(19) United States
(12) Patent Application Publication
(10) Pub. No.: US 2013/0112617 A1
(43) Pub. Date: May 9, 2013

(54) Redox wastewater biological nutrient removal treatment method

(71) Applicants: Marcus G. Theodore, Salt Lake City, UT (US); Terry R. Gong, Moraga, CA (US)

(72) Inventors: Marcus G. Theodore, Salt Lake City, UT (US); Terry R. Gong, Moraga, CA (US)

(73) Assignee: Earth Renaissance Technoloogies, LLC, Salt Lake City, UT (US)

(21) Appl. No.: 13/373,169

(22) Filed: Nov. 7, 2011

(51) Int. Cl. C02F 9/00

(52) U.S. Cl. 210/631

(57) ABSTRACT

A redox water biological nutrient removal treatment method utilizing sulfurous acid to act as either an oxidizing or a reducing solution via pH adjustment for water conditioning and bacterial treatment.

### BACKGROUND OF THE INVENTION

1. Field

This invention pertains to wastewater biological removal treatment processes. In particular it pertains to a redox wastewater biological nutrient removal treatment method utilizing sulfurous acid to act either as an oxidizing or a reducing solution for water conditioning.

2. State of the Art

Various wastewater biological treatment methods are known to remove nitrogen and phosphorous by adjusting the conditions in bioreactors for nitrifying and denitrifying bacteria and phosphate accumulating organisms. Usually this involves adjusting the oxygen flows, but may involve intensification of the denitrification process by adding additional carbon sources, such as ethanol, methanol, and other polyglycols.

Various water treatment methods using sulfurous acid are also known. Harmon et al, U.S. Pat. No. 7,566,400 issued Jul. 28, 2009 discloses a wastewater chemical/biological treatment method and apparatus for saline wastewater treatment generating biofuels. Harmon et al, U.S. Pat. No. 7,455,773 issued Nov. 25, 2008 discloses a package wastewater chemical/biological treatment plant recovery apparatus and method including soil SAR conditioning. Theodore, U.S. Pat. No. 7,416,668 issued Aug. 26, 2008 discloses a wastewater chemical/biological treatment plant recovery apparatus and method employing sulfurous acid disinfection of wastewater for subsequent biological treatment. Theodore, U.S. Pat. No. 7,563,372 issued Jul. 21, 2009 discloses a package dewatering wastewater treatment system and method including chemical/mechanical separation via drain bags and metal hydroxide removal via lime precipitation. Theodore, U.S. Pat. No. 7,429,329 issued Sep. 30, 2008 discloses a hybrid chemical/mechanical dewatering method and apparatus for sewage treatment plants employing sulfurous acid and alkalinization chemical treatment along with mechanical separation. Theodore et al, U.S. Pat. No. 7,967,990 issued Jun. 28, 2011 discloses a hybrid chemical/mechanical dewatering method for inactivating and removing pharmaceuticals and other contaminants from wastewater employing a sulfurous acid and lime acidification/alkalinization cycle, and an oxidation/reduction cycle to selectively precipitate, inactivate, and remove pharmaceuticals from wastewater. Gong et al, U.S. Pat. No. 7,967,989 issued Jun. 28, 2011 discloses a groundwater recharging wastewater disposal method and apparatus using sulfurous acid acidification to enhance soil aquifer treatment. Harmon et al, U.S. Pat. No. 7,867,398 issued Jan. 11, 2011 discloses a method and apparatus to reduce wastewater treatment plant footprints and costs by employing vacuum recovery of surplus sulfur dioxide.

Wastewaters to be treated vary in nutrient composition, alkaline and saline ionic concentrations, and may require biological nutrient removal treatment using, either a pre-treatment reducing agent or oxidizing agent. There thus remains a need for a method to adjust the wastewater oxidation and reduction conditions for optimal bacterial nutrient removal. The method described below regulating the electrical oxidation reduction potential of sulfurous acid treated wastewaters entering biological nutrient removal systems for removal of suspended solids before balancing with lime to remove heavy metals and phosphates provides such a pre-treatment method.

### SUMMARY OF THE INVENTION

### Method

The present invention comprises a redox wastewater biological nutrient removal treatment method employing sulfurous acid and lime to condition wastewater and wastewater streams for better biological nutrient removal. The redox wastewater biological nutrient removal treatment method comprises first determining the composition of the wastewater to be treated and whether the wastewater requires biological nutrient removal under oxidation or reduction conditions, or both.

Next, sulfur dioxide (SO₂) is injected into the wastewater or wastewater stream to be treated to provide H⁺, SO₂, SO₃⁼, HSO₃⁻, dithionous acid (H₂S₂O₄), and other sulfur intermediate reduction products forming a disinfected sulfur dioxide treated wastewater with agglomerated suspended solids and acid leached heavy metals in solution, which form either:
i. an oxidizing solution in the presence of oxygen and additional acid to insure that the electrical conductivity level of the sulfur dioxide treated wastewater is sufficient to accept electrons, or
ii. a reducing solution in the presence of minimal oxygen and no additional acid to insure the electrical conductivity level of the sulfur dioxide treated wastewater is sufficient for release of electrons.

The suspended solids are then removed forming an oxidizing or reducing solution filtrate.

Lime is then added to the oxidizing or reducing solution filtrate to precipitate heavy metals as metal hydroxides, and phosphates as calcium phosphate precipitates, which are then removed, and the pH adjusted to that required by the bacteria in the bioreactor forming a pH adjusted oxidizing or reducing solution.

The oxidation reduction potential electrical conductivity levels of a bioreactor used for bacterial removal of nutrients from wastewater is measured to determine if the bioreactor requires either an oxidizing or reducing solution, or both.

The pH adjusted oxidizing solution or reducing solution, or both, are then directed through the bioreactor to accelerate biological removal of nitrogen compounds.

Where removal of the suspended solids creates a carbon source deficiency for the bioreactor denitrifying bacteria to act, spent lime (Calcium carbonate) is used to neutralize the sulfurous acid to precipitate the metal hydroxides and phosphates and add additional bicarbonates for feeding the denitrifying bacteria. The bicarbonates added result in a buffered environment in the mixed liquor and provided a suitable means to maintain the pH in the desirable range of 7-8.2 for denitrification. Bicarbonate as the only carbon source causes hydrogenotrophic denitrifying bacteria, using bicarbonate and hydrogen gas in the aforementioned pH range, to denitrify at a rate of 13.33 mg NO₃⁻-N/g MLVSS/h for degrading 20 and 30 mg NO₃⁻-N/L and 9.09 mg NO₃⁻-N/g N/g MLVSS/h for degrading 50 mg NO₃⁻-N/L.

Alternatively, courser filters may be used for partially removing the suspended solids allowing some to pass into the bioreactor as an added carbon source.

Dissolved oxygen (DO) and oxidation reduction potential (ORP) meters are used to determine conditions inside sequential batch reactors or other biological nutrient removal treatment systems to determine the oxidation reduction potential required for optimal removal of nitrogen and phosphorous.

Biological removal of nitrogen is a two-part reaction called nitrification and denitrification. Nitrification takes place under oxic or aerated conditions, where nitrifying bacteria known as nitrosomonas convert the influent ammonium to nitrite. Another group of nitrifying bacteria known as nitrobacteria then convert the nitrite to nitrate using free oxygen, under the right alkalinity, pH, and temperature conditions given enough time.

Denitrification then removes the nitrogen, facultative bacteria consume organic carbon sources in the wastewater under anoxic (no free dissolved oxygen) conditions. Facultative bacteria use free dissolved oxygen, nitrate, sulfate, and carbon dioxide as an oxygen source. If free DO is not available, they break apart chemical bonds holding the nitrogen and oxygen together in a nitrate molecule (NO₃) and utilize the oxygen, freeing the nitrogen as nitrogen gas.

Nitrification and denitrification may be accomplished as separate sequential reactions in separate bioreactors, or combined into one bioreactor, such as sequential batch reactors or sequential membrane reactors, which sequentially perform first nitrification and then denitrification. These biological nutrient treatment methods generally rely on blowing in air and oxygen for increasing oxic or aerobic conditions, and then turning off the blowers to create anoxic anaerobic conditions for bacterial nutrient removal.

Tracking oxidation reduction potential (ORP) within a bioreactor is an effective way of measuring the oxygen source that is available to microorganisms. While a DO meter is a good way of measuring residual dissolved oxygen, it doesn't give an accurate representation of the oxygen source is available when DO gets to 0.2 mg/L and lower.

ORP ranges required for nitrification and denitrification are typically +50 to about +225 mV and indicate the presence of dissolved oxygen (O₂). An ORP reading of +225 to +400 mV indicates the presence of oxygen and nitrate (NO₃). ORP readings in the range of +50 to −50 mV indicate that no free available dissolved oxygen is present and nitrate is present as an electron acceptor—the range needed for anoxic tanks and timed anoxic cycles. There should be no free DO present in this zone so a DO meter would read zero mg/L. ORP readings less than −50 mV indicate there is no free oxygen or nitrate present, and the microorganisms would be utilizing sulfate (SO₄) as an electron acceptor for their energy requirements.

FIG. 1 shows ORP and metabolic process readings for organic carbon oxidation, polyphosphate development, nitrification, denitrification, polyphosphate breakdown, sulfide formation acid formation and methane formation. The present method uses simple sulfurous acid and lime organic chemicals to alter the ORP readings to provide the necessary oxidation reduction potentials to improve bacterial nutrient removal. Applicant's organic chemicals may include spent lime (calcium carbonate), which eliminates the need for additional oxidants and carbon sources, such as methanol, ethanol, acetate, and polyglycols to enhance bacterial nutrient removal conditions. These other carbon additives are expensive, and require continual monitoring so that they don't leave unwanted reactants in the treated wastewater.

The present method has the advantage of chemical precipitation and removal of phosphates eliminating the need for the employment of phosphate-accumulating organisms (PAOs) bioreactors to release the maximum polyphosphate during the anaerobic (fermentation) phase. Thus, for phosphate removal there is no need to control dissolved oxygen and nitrate available to these obligate aerobic bacteria, which utilize the incoming BOD containing volatile fatty acids as a food source.

Sulfurous acid components (free SO₂, sulfites, bisulfites, etc.) not only act as reducing agents to scavenge oxygen and break down PPCP's, but the bisulfites act as buffering agents to help maintain desired pH levels within bioreactors. These chemicals thus provide a plant operator with another additive to off-set oxygen addition, where necessary to enhance anoxic or anaerobic conditions. Alternatively, they may be. acid adjusted by an operator to provide oxidizing conditions as described below.

Sulfurous acid also behaves as both an oxidizing and reducing agent and may be affected by the presence of other ions in solution, but in general, the acidic sulfur compounds reduce to a lower oxidation state in accordance with the reaction:

3HSO₃⁻=SO₄⁼+S₂O₄⁼+H⁺30 H₂O−4660 cal. (4)

The sulfurous acid and dithionous acid electro-motivate the electrode potential so the actual electrode reaction is

S₂O₄⁼+2H₂O=2H++2HSO₃⁻+2 E⁻+415 cal or (5)

S₂O₄⁼=2SO₂(g)+2E⁻+5015 cal (6)

The dithionous acid decomposes in the presence of large hydrogen ion concentrations according to the equation:

2S₂O₄⁼+H⁺+H₂O=S(s)+3HSO₃⁻+46,590 cal (8)

Sulfur rapidly unites with sulfurous acid to form thiosulfuric acid, but until it has significant concentration, the dithionous acid decomposes in accordance with the equation

2S₂O₄⁼+H₂O=S₂O₃⁼+2HSO₃⁻+44,015 cal (9)

The free-energy values show that Reactions 4, 8 and 9 tend to take place in the direction in which they are written (when the other ion concentrations are 1 molal). At 1 molal, the S₂O₄⁼ has the following values:

Reaction 4, when it is less than 0.0004 molal.

Reaction 8, when it is greater than 10⁻¹⁷ molal

Reaction 9, when it is greater than 10⁻¹⁶ molal.

Thus, sulfurous acid behaves either as a reducing agent or an oxidizing agent depending on the nature of the combination acted upon and the strength of the acid. Further, at a given acid concentration the reduction potential of the combination acted upon need only be varied by a relatively small amount (20 to 40 mV.) in order to change the action of sulfurous acid from a reducing agent to an oxidizing agent. An increase in acid concentration thus makes sulfurous acid a less powerful reducing agent, and a more powerful oxidizing agent.

If a reducing solution is required for wastewater treatment, the sulfur dioxide is injected into the wastewater without the addition of additional acid. If an oxidizing solution is required, the sulfur dioxide is injected with air, an oxidizing agent, such as hydrogen peroxide, ferric or ferrous compounds and the pH lowered to provide the oxidizing solution. Oxidation may thus require the addition of additional acid. The type of additional acid is selected so that the cations added do not adversely affect the composition of the resultant treated water. For example, sulfurous or sulfuric acid is preferable to hydrochloric acid as the monovalent chlorides adversely affect the salinity of the recovered treated wastewater when applied to soils, whereas the bivalent sulfates do not.

If both reduction and oxidization is required for biological water treatment in a single vessel, first the sulfur dioxide is added to the water forming sulfurous acid with air to create an oxidizing solution and held for the dwell time for the bacterial oxidation mechanisms to effectively denitrify the nitrogen compounds until the oxygen is exhausted. The air is then shut off so the sulfurous acid treated wastewater acts as reducing agent to feed the nitrification bacteria for nitrate removal. The sulfurous acid treated wastewaters are then pH adjusted to a level required by the end user, and to precipitate any heavy metals and phosphates contained therein for filtration removal. Lime has the additional advantage of providing calcium to adjust the sodium adsorption ration (SAR) when required for soil treatment.

With complex waters, such as wastewater, numerous other components are present. Therefore the amount of sulfurous acid and pH adjustment required must be determined in the field by trial and error as bicarbonates, and other compounds materially affect the amount of sulfur dioxide and acid required for oxidation and reduction. However, the initial estimates of the amount of sulfurous acid may be based on laboratory studies of pure solutions, such as the Noyes and Steinour studies, which found:

“. . . ”Sulfur dioxide at 25° at 1 atm. in an aqueous solution containing hydrogen ion at 1 molal may be expected to behave toward other oxidation-reduction combinations of substances in three different ways according to the reduction potential of the latter [is:] (a) is more negative than −0.37 volt; (b) lies between −0.37 and −0.14 volt; and (c) is more positive than −0.14 volt. (It may be recalled that the value −0.37 is the potential which sulfur dioxide has, under the specified conditions, with respect to its conversion into dithionite ion S₂O₄⁼ as it exists in the steady reaction state, and that −0.14 is the potential which it has with respect to its conversion to sulfate ion, SO₄⁼, at 1 molal.) For it is evident that sulfur dioxide may oxidize any combination with a reduction potential more reducing (less negative) than −0.37 volt, and that it may reduce any combination which has a potential more oxidizing (more negative) than −0.14 volt. Therefore it may either oxidize or reduce any combination with a potential between −0.37 and −0.14 volt, and which of these two possible effects actually occurs will depend on the relative rates of the oxidizing reaction and the reducing reaction.”

Thus, after determining the water's composition and whether water treatment requires either an oxidizing or reducing solution, or both, sulfur dioxide (SO₂) with minimal oxygen or oxygen containing compounds is injected into the water to create a reducing solution in one mode, or sufficient oxygen or oxygen containing compounds into the sulfur dioxide treated water to create an oxidizing solution in another mode.

The acid pH concentration is similarly adjusted to either insure the electrical conductivity level of the sulfur dioxide treated water is sufficient for release of electrons from the sulfur dioxide, sulfites, bisulfites, and dithionous acid to form a reducing solution to:
i. reduce oxidants,
ii. disinfect pathogens,
iii. acid leach heavy metals from suspended solid into solution, or
iv. self agglomerate suspended solids.

Alternatively, the acid concentration is increased sufficiently to accept electrons when the sulfurous acid treated water acts as an oxidizing solution.

Where self agglomerating suspended solids are present, they are removed and disposed of after sulfur dioxide treatment along with any adsorbed polar molecules to produce a filtrate containing heavy metals. Conditioning of these solids is defined as treating the solids with sufficient SO₂ allowing them chemically to self adhere to aid in their separation and removal from filtration screens or membranes, but at a level not affecting the permeation characteristics of a filter or membrane. Based on field tests at the Montalvo Municipal Improvement District wastewater treatment plant, self agglomeration occurs at a pH of approximately 3 to 6.5 resulting in fine suspended solids, which drop to the bottom of percolation ponds, leaving a clear effluent where the bottom can be seen at a depth of 7 to 8 feet as opposed to 2 feet with no acid treatment. These separated conditioned solids chemically dewater upon draining to a water content of less than 10%.

The electrical conductivity within a bioreactor varies based on the composition of the wastewaters to be treated. Once the proper environmental conditions were provided to the bacteria, the nutrient removal processes work well. When the wastewater contains more oxidizing agents than reducing agents, the ORP shows a high (positive) value. Where there are more reducers than oxidizers, the ORP reads in the negative rage. For example, raw wastewater containing much ammonia nitrogen and little dissolved oxygen (DO) has ORP normally reading in the negative range (−50 to −150 mV). The more septic the wastewater, the lower the ORP reading. ORP readings in a chlorine contact tank are just the opposite as ORP climbs very high due to the amount of an oxidizer like chlorine, where readings might be as high as +400 to +700 mV.

In aeration tanks, ORP values are around +50 to +200, and if nitrate is also present, the ORP values might go up to +300 mV. When denitrifying in an anoxic tank or zone, ORP values of from +50 to −100 mV are typically present.

Keeping oxygen levels at optimum concentrations is necessary to maintain aerobic conditions. DO levels between 1.0 to 3.0 mg/L are acceptable, however DO concentrations over 3.0 mg/L provide no additional benefit. Keeping constant DO levels below 0.5 mg/L can contribute to the growth of filamentous organisms, which can cause slow settling in clarifiers (sludge bulking).

Thus sulfurous acid wastewater treatment may be used with or without oxygen to adjust the oxidation reduction potential within a bioreactor.

The basic acid disassociation chemical reactions of SO₂ in water are:

SO₂+H₂O [symbol] H₂SO₃ sulfurous acid

H₂SO₃ [symbol] H⁺+HSO₃⁻bisulfite pK=1.77

HSO₃⁻ [symbol] H⁺+SO₂⁻ sulfite pK=7.20

This means 50% of the SO₂ is gas at pH 1.77 and 50% is HSO₃⁻. In a similar manner, 50% is HSO₃⁻ and 50% is SO₃²⁻ at pH 7.2. Halfway between pH 7.2 and 1.77 and 1.77 is 5.43 as the pH where all of the sulfur exists as the HSO₃⁻ form. At a pH of 10.86, all of the sulfur should exist as SO₃²⁻.

Although sulfur dioxide from tanks associated with a contact mixer can be used to acidify the wastewater to be pretreated, a sulfurous acid generator, such as those produced by Harmon Systems International, LLC of Bakersfield, California, is preferred as they are designed to produce the SO₂ on demand and on an as needed basis. The SO₂ is immediately captured in an aqueous form as sulfurous acid (H₂SO₃) preventing harmful operator exposure. The sulfur dioxide is injected into the wastewater at a pH between approximately 1.5 and approximately 3.5, depending upon the dwell time required for conditioning and disinfection. At these pH ranges, sufficient SO₂ is generated to condition solids for separation, and disinfection and deodorizing wastewater. It was found through testing the Harmon sulfurous acid generator can condition and treat incoming raw wastewater solids to self agglomerate into colloidal self adhering solids which do not adhere to surfaces The Harmon sulfurous acid generator has the advantage of generating SO₂, as needed, avoiding the dangers of SO₂ tank storage. However, the main advantage in passing the water directly through the sulfurous acid generator is that it creates and introduces onsite SO₂ without adding other compounds or materials such as when using sodium meta-bisulfite and/or potassium meta bisulfite into the system, or additional acid compounds for pH lowering. The method uses both unfiltered and filtered water as the medium to scrub and form the sulfurous acid. Consequently, the treated water volume is not affected.

When operating a wastewater treatment facility that has an aerobic digester for waste sludge stabilization and plant hydraulic capacity is not limited, it can be beneficial to return digester supernatant during high daily flow periods. Since aerobic digester supernatant can be high in nitrate, this supernatant can be used as a source of oxygen in anoxic basins or during anoxic periods. This same supernatant can also be the cause of high nitrate results during regular effluent sampling required by the operating permit.

One embodiment of the redox wastewater biological nutrient removal treatment method includes removing and disposing of the self agglomerated suspended solids with adsorbed polar molecules from solution to produce a filtrate containing heavy metals. The filtrate pH is raised with lime to precipitate heavy metals for removal as metal hydroxides and phosphates as calcium precipitates forming a disinfected demetalized filtrate suitable for biological treatment. The disinfected demetalized filtrate reclaimed wastewater is then conditioned to adjust the pH and calcium ion concentration to provide soil concentrations of SAR less than 15, EC less than 2 dS m⁻¹ (m mho cm⁻¹), CEC less than 57.5 centimoles/kg, and a pH less than 8. The specific soil ratios and concentration levels may vary and are selected for raising a particular crop and reduce soil bicarbonates/carbonates to increase soil porosity and improve water penetration.

In summary, additional oxidizing agents may be required for addition to the sulfur dioxide treated wastewater oxidizing solution, hydrogen peroxide, oxygen containing compounds, and ferrous compounds may be added to adjust the electrical conductivity level sufficient to accept electrons to enhance the oxidizing solution. Where additional reducing agents are required for addition to the sulfur dioxide treated wastewater reducing solution, additional sulfites and bisulfites may be added to adjust the electrical conductivity levels sufficient to donate electrons to enhance the reducing solution.

For batch treatment, sufficient sulfurous acid is added to support both the oxidation and reduction stages of the bioreaction. After the oxidation phase is completed, there is a transition point, wherein the sulfur dioxide treated wastewater has an ORP at the point of transition between oxic or aerobic conditions and anoxic anaerobic conditions where the sulfurous acid is suitable to support reduction of the nitrates to nitrogen gas. Usually, the sulfur dioxide treatment wastewater ORP is approximately +50 mV at this point as shown in FIG. 1, but varies based on wastewater conditions and nutrient loads.

The above method provides a redox water treatment method to produce waters suitable for various soil regions, and soil conditions

### DESCRIPTION OF THE DRAWINGS

FIG. 1 is a graph of ORP and Metabolic Processes prepared by Gronsky, et al, 1992

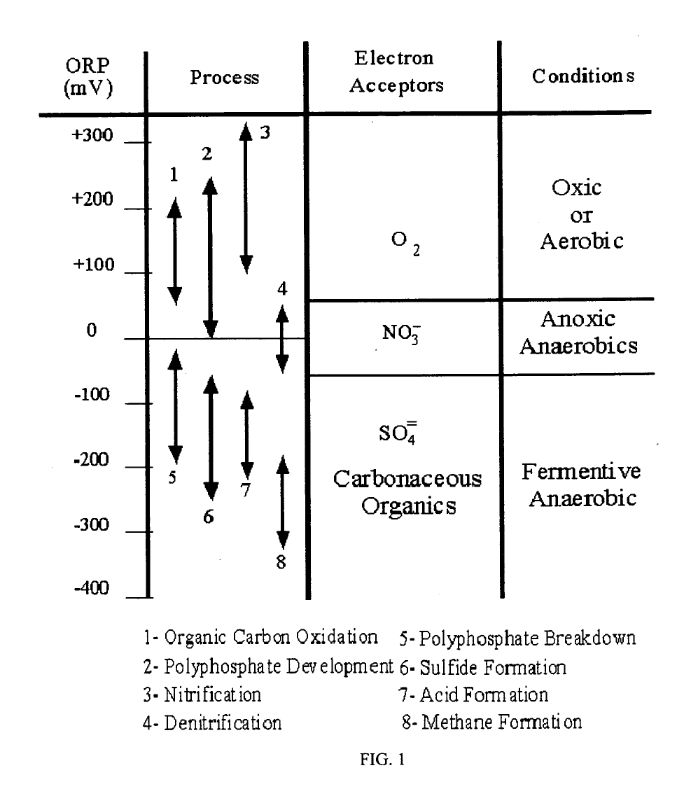

We claim:

1. A redox wastewater biological nutrient removal treatment method employing sulfurous acid and lime comprising:
a. determining the composition of wastewater or wastewater process streams to be treated and whether the wastewater and wastewater process steams require biological nutrient removal under oxidation or reduction conditions, or both,
a. injecting sulfur dioxide (SO₂) into the wastewater to be treated to provide H⁺, SO₂, SO₃⁼, HSO₃⁻, dithionous acid (H₂S₂O₄), and other sulfur intermediate reduction products forming a sulfur dioxide treated wastewater with agglomerated suspended solids and acid leached heavy metals in solution, which form either:
i. in the presence of oxygen and sufficient acid to insure that the electrical conductivity level of the sulfur dioxide treated wastewater is sufficient to accept electrons to create an oxidizing solution, or
ii. in the presence of minimal oxygen and no additional acid to insure the electrical conductivity level of the sulfur dioxide treated wastewater is sufficient for release of electrons from the sulfur dioxide, sulfites, bisulfites, and dithionous acid to form a reducing solution
c. removing the suspended solids forming an oxidizing or reducing solution filtrate,
d. adding lime to the oxidizing or reducing solution filtrate to precipitate heavy metals as metal hydroxides, and phosphates as calcium phosphate precipitates,
e. removing metal hydroxides and calcium phosphate precipitates forming a pH adjusted oxidizing or reducing solution; and
f. selectively directing either a pH adjusted oxidizing solution or reducing solution, or both through the bioreactor to accelerate biological removal of nitrogen compounds forming a conditioned wastewater.

2. A redox wastewater biological nutrient removal treatment method according to claim 1, including measuring and monitoring the oxidation reduction potential electrical conductivity levels of a bioreactor used for bacterial removal of nutrients from wastewater to determine if the bioreactor requires an oxidizing or reducing solution, or both

3. A redox wastewater biological nutrient removal treatment method according to claim 2, wherein the electrical conductivity is between −0.37 and −0.14 volt at 25° C. at 1 molal H⁺ for denitrification.

4. A redox wastewater biological nutrient removal treatment method according to claim 1, wherein the lime added is spent lime to add additional carbon if required by the denitrifying bacteria.

5. A redox wastewater biological nutrient removal treatment method employing sulfurous acid according to claim 1, including injecting hydrogen peroxide, oxygen containing compounds, and ferrous compounds into the sulfur dioxide treated wastewater oxidizing solution to adjust the electrical conductivity level of the sulfur dioxide treated wastewater is sufficient to accept electrons to enhance the oxidizing solution.

6. A redox wastewater biological nutrient removal treatment method according to claim 5, including adding additional acid to the sulfur dioxide treated wastewater to make a more powerful oxidizing solution.

7. A redox wastewater biological nutrient removal treatment method according to claim 6, wherein the additional acid for oxidation is selected to provide compatible anions consistent with the discharge needs of the end user.

8. A redox wastewater biological nutrient removal treatment method according to claim 1, including adding additional sulfites and bisulfites to the sulfur dioxide treated wastewater reducing solution to adjust the electrical conductivity level of the sulfur dioxide treatment wastewater is sufficient to donate electrons to enhance the reducing solution.

9. A redox wastewater biological nutrient removal treatment method according to claim 1, including adding lime and calcium carbonate to adjust the pH and calcium ion concentration of the conditioned wastewater to provide soil concentrations of SAR less than 15, EC less than 2 dS m⁻¹ (m mho cm⁻¹), CEC less than 57.5 centimoles/kg, and a pH less than 8; the specific soil ratios and concentration levels selected for raising a particular crop and reduce soil bicarbonates/carbonates to increase soil porosity and improve water penetration.

10. A redox wastewater biological nutrient removal treatment method according to claim 9, wherein the concentration of sulfurous acid of the conditioned wastewater has a pH between 2 and 6.8 for alkaline soil land application.

11. A redox wastewater biological nutrient removal treatment method according to claim 1, wherein the oxidizing solution is first raised to a pH level of up to 11 using lime to precipitate any heavy metals as metal hydroxides for removal, and the resultant metal free filtrate is then pH lowered for raising plants and soil biological treatment, and providing a soil SAR level suitable for plant propagation and reduce soil carbonates/bicarbonates to improve water penetration.

12. A redox wastewater biological nutrient removal treatment method according to claim 1, wherein the sulfurous acid reducing solution has a free SO₂ and bisulfite (HSO₃⁻) concentration, a pH level, and a dwell time sufficient to affect disinfection of the conditioned wastewater before land application.

13. A redox wastewater biological nutrient removal treatment method employing sulfurous acid and lime comprising:
a. determining the composition of wastewater or wastewater process streams to be treated in a sequential batch reactor requiring biological nutrient removal under both oxidation and reduction conditions,
b. injecting sulfur dioxide (SO₂) and oxygen into the wastewater to be treated to provide H⁺, SO₂, SO₃⁼, HSO₃⁻, dithionous acid (H₂S₂O₄), and other sulfur intermediate reduction products forming a sulfur dioxide treated wastewater with agglomerated suspended solids and acid leached heavy metals in solution under oxic or aerobic conditions where the oxidation reduction potential is sufficient for the sulfur dioxide treated water to accept electrons to create an oxidizing solution for nitrification to occur for bacteria to break down ammonia into nitrite and then into nitrate compounds,
c. stopping oxygen injection to form a reducing solution under anoxic anaerobic conditions where the ORP is to insure that the electrical conductivity level of the sulfur dioxide treated wastewater is sufficient to donate electrons to create a reducing solution for denitrification to occur where bacteria to break down the nitrates into nitrogen,
d. removing the suspended solids forming a filtrate,
e. adding lime to the filtrate to precipitate heavy metals as metal hydroxides, and phosphates as calcium phosphate precipitates, and
f. removing metal hydroxides and calcium phosphate precipitates forming a pH adjusted recovered wastewater.

14. A redox wastewater biological nutrient removal treatment method according to claim 13, wherein the sulfur dioxide treated wastewater under oxic or aerobic conditions has an ORP is between +50 and +300 mV and an ORP between +50 and −50 mV under anoxic anaerobic conditions.
